(19) United States
(12) Patent Application Publication
(10) Pub. No.: US 2018/0079664 A1
(43) Pub. Date: Mar. 22, 2018

(54) Wastewater Odor Control

(71) Applicant: Pencco, Inc., San Felipe, TX (US)

(72) Inventor: Vincent Marano, Temecula, CA (US)

(21) Appl. No.: 15/710,265

(22) Filed: Sep. 20, 2017

Related U.S. Application Data
(60) Provisional application No. 62/398,053, filed on Sep. 22, 2016.

(51) Int. Cl. C02F 1/52; C02F 1/58; C01G 49/00

(52) U.S. Cl. CPC C02F 1/5236; C02F 2101/101; C01G 49/0081; C02F 1/58

(57) ABSTRACT

Methods and apparatus for controlling odor of wastewater are described. An example method includes dispensing a solution in wastewater. The solution comprises an iron-nitrate compound mixed in water. In some examples, the iron-nitrate compound is ferric nitrate and/or ferrous nitrate. In some examples, the solution further includes an iron ion source different from the iron-nitrate compound, such as an iron salt like ferrous sulfate, ferrous chloride, or the like. The dispensing can be by using a feeding station in a wastewater collection system.

This application claims priority to and the benefit of U.S. Provisional Patent Application Ser. No. 62/398,053, filed on Sep. 22, 2016, the disclosure of which is incorporated herein by reference in its entirety.

### BACKGROUND OF THE DISCLOSURE

Wastewater collection and treatment systems have been implemented in many areas of the world. Wastewater can be generated from many sources. It is treated to improve quality of water that is discharged out to the environment or reclaimed. Effective collection of wastewater is directed to minimizing inconvenience and odors that may be emitted by a collection system.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified schematic view of an example collection system.

FIG. 2 is a simplified schematic view of an example feeding station of a collection system.

FIG. 3 is a simplified schematic of an example processing system.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed.

Wastewater generated, for example, at a residential location, by storm water, etc., is often collected in a collection system, and the wastewater is conveyed to a wastewater treatment plant through the collection system. Wastewater in a collection system can generate chemicals via biological and chemical reactions that, when released in gaseous form, emit foul odors. An example of one of these chemicals is hydrogen sulfide (H₂S). Examples described herein may treat wastewater in a collection system to reduce an amount of hydrogen sulfide in the wastewater. Concepts described herein may be applied to reducing an amount of another chemical in wastewater. Further, concepts described herein may be applied in other contexts where hydrogen sulfide may be generated, such as in a retention pond, a storage tank in which rain water is stored (like in the oil and gas industry), and/or other example containers.

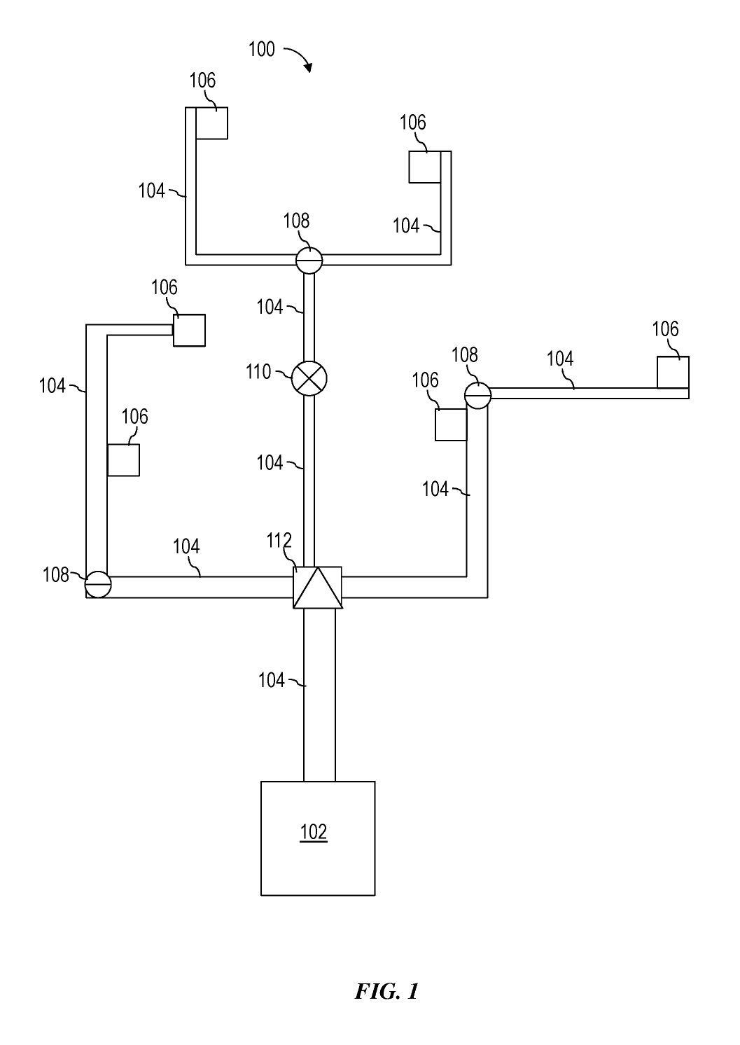

FIG. 1 depicts a simplified schematic of a collection system 100 through which wastewater is conveyed to a wastewater treatment facility 102. The collection system 100 includes a network of pipes 104 fluidly coupled together to convey wastewater to the wastewater treatment facility 102. The pipes 104 can be any size, e.g., 60 inch, 48 inch, etc., and in some examples, the pipes 104 can be differing sizes throughout the collection system 100. The pipes 104 may also or instead be or include conduit, channels, or the like. The network of pipes 104 receives wastewater from a number of wastewater sources 106. Each of the wastewater sources 106 is fluidly coupled to the network of pipes 104. The wastewater sources 106 can be, for example, residential or commercial buildings, office complexes, consumer complexes, storm drains, and/or the like. Generally, the network of pipes 104 receives wastewater from the wastewater sources 106 and conveys the wastewater to the wastewater treatment facility 102, where the wastewater is treated and subsequently discharged to the environment or reclaimed.

Manholes 108 can be located in various positions throughout the collection system 100. Each of the manholes 108 can allow for physical access to the network of pipes 104 at the location of the respective manhole 108. For example, a manhole 108 can allow for maintenance personnel to physically enter the network of pipes 104 for maintenance or to take a sample of the wastewater in the network of pipes 104.

Each of the pipes 104 may be a force main and/or a gravity main. In a gravity main pipe, conveyance of wastewater is by gravity, e.g., the wastewater flow direction is towards a decline. In a force main pipe, conveyance of wastewater uses an applied force, such as by a pump, and the wastewater flow direction can be towards an incline. In a collection system 100 that includes a force main pipe, a wet well 110 can be included to supply an applied force, such as is illustrated in FIG. 1. A wet well 110 can include a tank and a pump. The tank can receive wastewater from a pipe 104. When the level of wastewater in the tank reaches a predetermined level, a sensor can be tripped to initiate the pump to start pumping wastewater, or to vary (e.g., increase) a flow of wastewater from the pump, from the tank to a force main pipe 104. The network of pipes 104 can include any combination of force main and gravity main pipes, and in some instances, the network of pipes 104 may not include any force main pipes or any gravity main pipes. The collection system 100 can include any number of wet wells 110, which can be at any location in the collection system 100.

Wastewater can include many types of fluids, chemicals, and organisms. For example, wastewater can include hydrogen sulfide and bacteria. When hydrogen sulfide is released in gaseous form from wastewater, the hydrogen sulfide can have a foul odor. Hydrogen sulfide can be released at greater rates at locations of turbulence of the wastewater in the collection system 100. Some locations of turbulence of the wastewater in the collection system 100 can be at a wet well 110 where wastewater is collected (e.g., dropped) into a tank and subsequently pumped out, at a transition point in a pipe 104 from a force main to a gravity main, and at an intersection of pipes 104 where different flow directions of wastewater intermingle.

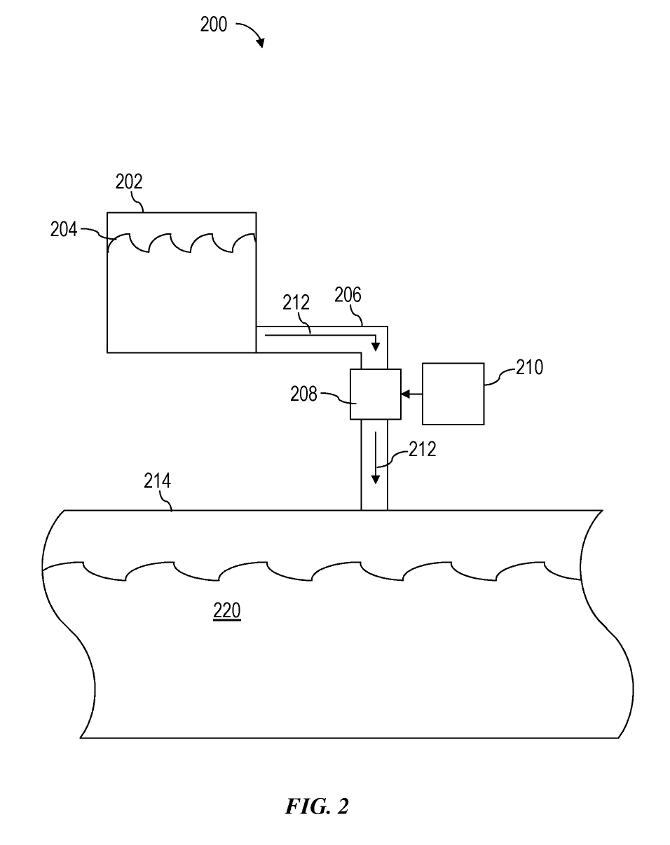

The collection system 100 includes a feeding station 112 that releases a treatment chemical into the network of pipes 104. The treatment chemical, in some instances, can be capable of reacting with and decomposing hydrogen sulfide in the wastewater. The treatment chemical, in some instances, can be capable of supplying oxygen for a biochemical oxygen demand (BOD) in the wastewater. Additional details of an example feeding station are illustrated in and described with respect to FIG. 2 below. The collection system 100 can include any number of feeding stations 112, which can be at any location in the collection system 100.

The collection system 100 depicted in and described with respect to FIG. 1 is used as an example herein. Other example collection systems can include any configuration of pipes, wastewater sources, manholes, wet wells, and feeding stations, among others. Some example collection systems can include additional components not depicted in the collection system 100 of FIG. 1, and/or may omit some components depicted in the collection system 100 of FIG. 1.

FIG. 2 illustrates a simplified schematic view of a feeding station 200, which may be an example of the feeding station 112 in the collection system 100 of FIG. 1. The feeding station 200 includes a tank 202 with an outlet 206. Treatment chemicals 204 are stored in the tank 202. Treatment chemicals 204 may be released 212 from the tank 202 through the outlet 206, which is controlled by a discharge control device 208. The outlet 206 may be a pipe, conduit, or the like fluidly coupled to the tank 202 proximate a bottom portion of the tank 202. The discharge control device 208 can be a control valve (such as a proportional control valve), a metering pump (such as a variable speed metering pump), or the like mechanically coupled to the outlet for controlling the discharge of the treatment chemical 204 from the tank 202. The discharge control device 208 is controlled by a controller 210, which may include a processing system as described below.

The outlet 206 is fluidly coupled to a pipe 214 of a collection system through which wastewater is conveyed. The pipe 214 can be any size, and in some examples, may also or instead be or include a conduit, a channel, or the like. In some examples, the outlet can be fluidly coupled to a tank of a wet well or another component in the collection system, for example. Wastewater 220 flows through the pipe 214 and can include a bulk liquid and sediment (also referred to as a “slime layer”). The bulk liquid may include suspended particulates and may include any liquid that is generated from a wastewater source. The slime layer may include particulates that settle out from the bulk liquid. The slime layer can include bacteria and other organic material.

The controller 210 controls the operation of the discharge control device 208 to thereby control the release 212 of the treatment chemical 204 from the tank 202 through the outlet 206 into the wastewater 220 in the pipe 214. The controller 210 can implement a program schedule that controls how the treatment chemical 204 is released 212, such as by controlling whether the release 212 is a discrete, instantaneous batch release, a continuous release, or a combination thereof; the rate of release; the period of a schedule of releases; or the like.

When treatment chemical 204 is released 212 into the wastewater in the pipe 214, chemical reactions between the treatment chemical 204 and components of the wastewater may occur. What reactions occur and behavior of the reactions can differ in the wastewater 220 depending on time, for example. Additional details of some of these reaction are described below in different examples.

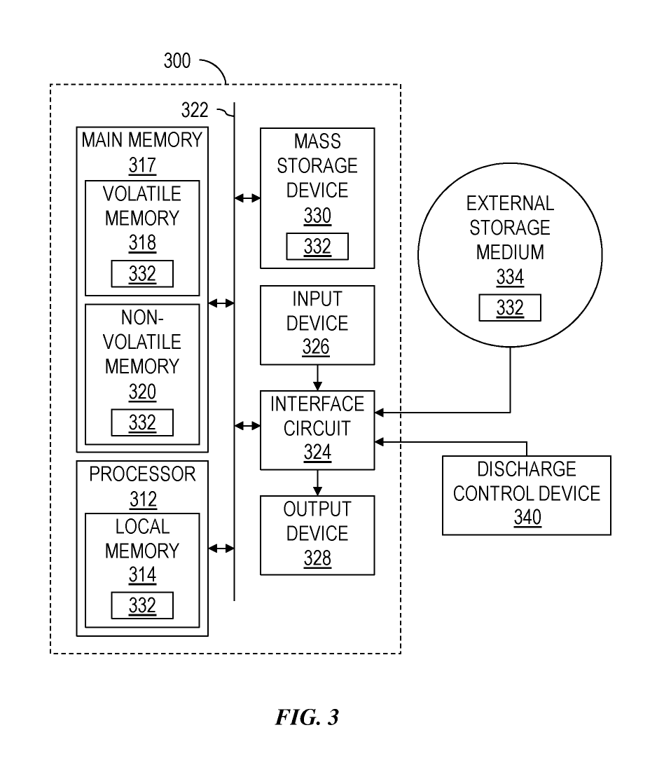

FIG. 3 is a simplified schematic view of an example processing system 300. The processing system 300 may execute machine-readable instructions to implement at least a portion of one or more program schedule for dispensing treatment chemicals. The processing system 300 may be implemented in the controller 210 of the feeding station 200 of FIG. 2 as described herein.

The processing system 300 may be or comprise, for example, one or more processors, controllers, special-purpose computing devices, and/or other types of computing devices. Moreover, while it is possible that the entirety of the processing system 300 shown in FIG. 3 is implemented within a controller of a feeding station, one or more components or functions of the processing system 300 may also or instead be implemented in various other equipment separate or remote from the feeding station.

The processing system 300 comprises a processor 312 such as, for example, a general-purpose programmable processor. The processor 312 may comprise a local memory 314, and may execute program code instructions 332 present in the local memory 314 and/or in another memory device. The processor 312 may execute, among other things, machine-readable instructions or programs to implement the methods and/or processes described herein. The programs stored in the local memory 314 may include program instructions or computer program code that, when executed by an associated processor, control operation of a flow control device, and thereby, release of a treatment chemical, according to a program schedule as described herein. The processor 312 may be, comprise, or be implemented by one or more processors of various types operable in the local application environment, and may include one or more general purpose processors, special-purpose processors, microprocessors, digital signal processors (DSPs), field-programmable gate arrays (FPGAs), application-specific integrated circuits (ASICs), processors based on a multi-core processor architecture, and/or other processors. More particularly, examples of a processor 312 include one or more INTEL microprocessors, microcontrollers from the ARM and/or PICO families of microcontrollers, embedded soft/hard processors in one or more FPGAs, etc.

The processor 312 may be in communication with a main memory 317, such as via a bus 322 and/or other communication means. The main memory 317 may comprise a volatile memory 318 and a non-volatile memory 320. The volatile memory 318 may be, comprise, or be implemented by tangible, non-transitory storage medium, such as random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 320 may be, comprise, or be implemented by tangible, non-transitory storage medium, such as read-only memory, flash memory and/or other types of memory devices. One or more memory controllers (not shown) may control access to the volatile memory 318 and/or the non-volatile memory 320.

The processing system 300 may also comprise an interface circuit 324. The interface circuit 324 may be, comprise, or be implemented by various types of standard interfaces, such as an Ethernet interface, a universal serial bus (USB), a third generation input/output (3GIO) interface, a wireless interface, and/or a cellular interface, among other examples. The interface circuit 324 may also comprise a graphics driver card. The interface circuit 324 may also comprise a communication device such as a modem or network interface card to facilitate exchange of data with external computing devices via a network, such as via Ethernet connection, digital subscriber line (DSL), telephone line, coaxial cable, cellular telephone system, and/or satellite, among other examples.

One or more input devices 326 may be connected to the interface circuit 324. One or more of the input devices 326 may permit a user to enter data and/or commands for utilization by the processor 312. Each input device 326 may be, comprise, or be implemented by a keyboard, a mouse, a touchscreen, a track-pad, a trackball, an image/code scanner, and/or a voice recognition system, among other examples.

One or more output devices 328 may also be connected to the interface circuit 324. One or more of the output device 328 may be, comprise, or be implemented by a display device, such as a liquid crystal display (LCD), a light-emitting diode (LED) display, and/or a cathode ray tube (CRT) display, among other examples. One or more of the output devices 328 may also or instead be, comprise, or be implemented by a printer, speaker, and/or other examples.

A discharge control device 340 may also be connected to the interface circuit 324. The discharge control device 340 can be the discharge control device 208 in the feeding station 200 of FIG. 2. The processing system 300 can control the operation of the discharge control device 340.

The processing system 300 may also comprise a mass storage device 330 for storing machine-readable instructions and data. The mass storage device 330 may be connected to the interface circuit 324, such as via the bus 322. The mass storage device 330 may be or comprise tangible, non-transitory storage medium, such as a floppy disk drive, a hard disk drive, a compact disk (CD) drive, and/or digital versatile disk (DVD) drive, among other examples. The program code instructions 332 may be stored in the mass storage device 330, the volatile memory 318, the non-volatile memory 320, the local memory 314, and/or on a removable storage medium 334, such as a CD or DVD.

The modules and/or other components of the processing system 300 may be implemented in accordance with hardware (such as in one or more integrated circuit chips, such as an ASIC), or may be implemented as software or firmware for execution by a processor. In the case of firmware or software, the implementation can be provided as a computer program product including a computer readable medium or storage structure containing computer program code (i.e., software or firmware) for execution by the processor.

The processing system 300 is operable to receive program code instructions that implement a program schedule to operate the discharge control device 340. The program code instructions 332 can be received, for example, through the interface circuit 324 by a wired or wireless connection and may be stored in any of, for example, volatile memory 318, non-volatile memory 320, mass storage device 330, and/or external storage medium 334. The processor 312 may access the program code instructions from memory and execute the program code instructions to output one or more signal through the interface circuit 324 to the discharge control device 340 to control the operation of the discharge control device 340. The processing system 300 can therefore implement a program schedule that identifies an amount, rate, period, duration, etc., of release of a treatment chemical into wastewater. In some examples, the program schedule identifies a continuous release rate at half hour increments for a seven-day period. Other examples can differ.

In some examples, a solution in which an iron-nitrate compound, such as ferric nitrate (Fe(NO₃)₃) and/or ferrous nitrate (Fe(NO₃)₂), is mixed is dispensed into a collection system, such as by the feeding station 200 of FIG. 2, for example. The solution may be an aqueous solution. Additionally, an iron (e.g., ferrous) ion source, such as an iron salt, may be mixed in the solution such that a blend of an iron-nitrate compound and an iron ion source are mixed in the solution. Some example iron salts include ferrous sulfate (FeSO₄), ferrous chloride (FeCl₂), the like, or a combination thereof. Other sources of iron and/or nitrate, and/or with various blends, are contemplated within the scope of this disclosure.

In a first example, a blend of ferric nitrate and ferrous sulfate is mixed in an aqueous solution, and the aqueous solution is dispensed in wastewater. A ratio by weight of the ferric nitrate to the ferrous sulfate in the blend can be equal to or greater than about 1:1, such as between about 1:1 and about 7:3, such as about 1:1. The blend may be mixed into water to form the aqueous solution with the blend being between about 15% and about 50% by weight of the aqueous solution, such as about 42% by weight. The active ferric nitrate can be about 30% by weight of the aqueous solution. The aqueous solution may be dispensed in wastewater to a concentration in a range from 1 parts per million (ppm) to 100 ppm, such as 20 ppm, in the wastewater. Other concentrations and ratios may be used consistent with the scope of this disclosure. For example, different concentrations and ratios may be appropriate for industrial applications.

The ferric nitrate dissolves in the wastewater to form a ferric cation (Fe³⁺) and a nitrate anion ((NO₃)⁻). The ferrous sulfate reacts with hydrogen sulfide (H₂S) in the wastewater as shown in Equation (1) below.

H₂S+FeSO₄‡FeS+H₂SO₄ Eq. (1)

The resultant ferrous sulfide (FeS) in Equation (1) can be inert and can precipitate out of the wastewater, which may visibly appear as dark or black flecks. Another product of the reaction of Equation (1) is sulfuric acid (H₂SO₄). The reaction in Equation (1) can occur largely in the bulk liquid of the wastewater. The reaction in Equation (1) can occur quickly; for example, it is theorized that the reaction in Equation (1) can occur in less than one minute.

The dissolved nitrate in the wastewater reacts with organic material, such as bacteria, and hydrogen sulfide as shown in Equations (2) and (3).

6(NO₃)⁻+5CH₃OH→5CO₂+3N₂+7H₂O+6(OH)⁻ Eq. (2)

6(NO₃)⁻+5H₂S→5(SO₄)⁻+4N₂+4H₂O+2H⁺ Eq. (3)

The organic material, such as bacteria, is represented by methanol (CH₃OH) in Equation (2) for illustration; other organic material may be present instead of and/or in addition to methanol. The methanol represents the biochemical oxygen demand (BOD) in the collection system. In Equation (2), the nitrate oxidizes the methanol, which results in carbon dioxide (CO₂), nitrogen (N₂), water (H₂O), and hydroxide anions ((OH)⁻). In Equation (3), the nitrate also oxidizes hydrogen sulfide to form sulfate anions ((SO₄)⁻), nitrogen, water, and hydrogen cations (H⁺).

The reactions in Equations (2) and (3) can occur in the bulk liquid and/or a sediment layer (also known as a “slime layer”) in the wastewater. The oxidation of bacteria by nitrate can reduce or eliminate production of hydrogen sulfide by the bacteria since the nitrate is a source of oxygen instead of sulfate. The reactions in Equations (2) and (3) can occur over a longer duration than the reaction in Equation (1); for example, it is theorized that the reaction in Equation (2) can occur over a duration of greater than or equal to about 30 minutes, such as between about 30 minutes and 2 hours. Additionally, it is theorized that the reaction of Equation (3) can continue to occur until at least one of the reactants, such as nitrate, is spent.

It is also theorized that bacteria in the wastewater may be able to oxidize the ferrous sulfide generated in Equation (1) to regenerate ferrous sulfate. Energy produced by reactions in Equations (2) and (3) may be able to overcome an activation energy to oxidize the ferrous sulfate. In some examples, the ferrous sulfide is not oxidized.

A product of Equation (2) is hydroxide anions. These hydroxide anions can increase the alkalinity of the wastewater. An increase in the alkalinity of the wastewater can increase the efficiency of an iron compound and nitrate anions reacting with hydrogen sulfide. Hence, a lower amount or concentration of ferric nitrate may be dispensed.

During the reactions of Equations (1) through (3), the ferric cation is reduced in the wastewater. The counter ion to the ferric cation that results in the oxidation can be any anion available in the wastewater, for example. It is hypothesized that, in some instances, sulfate anions may be present in relatively large quantities in wastewater such that ferric sulfate (Fe₂(SO₄)₃) can be produced in large quantities in the wastewater by the oxidation in those instances. Additionally, it is theorized that the ferric cations will bond with hydroxyl groups in the wastewater to form ferric hydroxide (Fe(OH)₃). Other example scenarios can create other ferric compounds, and any ferric compound created is contemplated within the scope of this disclosure.

When the nitrate is spent due to the reactions in Equations (2) and (3), any remaining bacteria in the wastewater may resume oxidization using sulfate that leads to the generation of hydrogen sulfide. In such a scenario, the reaction of Equation (1) may resume and continue to occur, such as using ferrous sulfate that was originally dispensed into the wastewater and/or ferrous sulfate that was regenerated in the wastewater, to form ferrous sulfide, which may precipitate out of the wastewater. Further, a multi-step reaction may occur such that a ferric compound, such as ferric sulfate as will be used in this example consistent with the above description, may be used to consume hydrogen sulfide and form ferrous sulfide as a product as shown in Equations (4) and (5). The reaction of Equation (4) precedes the reaction of Equation (5).

H₂S+Fe₂(SO₄)₃→S+2FeSO₄+H₂SO₄ Eq. (4)

H₂S+FeSO₄‡FeS+H₂SO₄ Eq. (5)

The reaction between hydrogen sulfide and ferric sulfate in Equation (4) results in sulfur (S), ferrous sulfate, and sulfuric acid. The ferrous sulfate that is a product of Equation (4) reacts with hydrogen sulfide in Equation (5) to result in ferrous sulfide and sulfuric acid, like previously described with respect to Equation (1). Additionally, ferric hydroxide formed from the ferric cation of the ferric nitrate can react with hydrogen sulfide to form ferrous sulfide as shown in Equation (6) below.

2Fe(OH)₃+3H₂S→S+2FeS+6H₂O Eq. (6)

The products of the reaction of Equation (6) between the ferric hydroxide and hydrogen sulfide are sulfur, ferrous sulfide, and water.

In a second example, ferric nitrate, in the absence of a blend with an additional iron source, is mixed in an aqueous solution, and the aqueous solution is dispensed in wastewater. The ferric nitrate may be mixed into water to form the aqueous solution with the ferric nitrate being between about 15% and about 50% by weight of the aqueous solution, such as about 42% by weight. The active ferric nitrate can be about 30% by weight of the aqueous solution. The aqueous solution may be dispensed in wastewater to a concentration in a range from 1 parts per million (ppm) to 100 ppm, such as 20 ppm, in the wastewater. Other concentrations and ratios may be used consistent with the scope of this disclosure. For example, different concentrations and ratios may be appropriate for industrial applications.

The ferric nitrate dissolves in the wastewater to form a ferric cation (Fe³⁺) and a nitrate anion ((NO₃)⁻). The dissolved nitrate in the wastewater reacts with organic material, such as bacteria, and hydrogen sulfide as shown in and described with respect to Equations (2) and (3) above. As described above, a product of Equation (2) is hydroxide anions. These hydroxide anions can increase the alkalinity of the wastewater. An increase in the alkalinity of the wastewater can increase the efficiency of an iron compound and nitrate anions reacting with hydrogen sulfide.

During the reactions of Equations (2) through (3), the ferric cation is oxidized in the wastewater. The counter ion to the ferric cation that results in the oxidation can be any anion available in the wastewater, for example. It is hypothesized that, in some instances, sulfate anions may be present in relatively large quantities in wastewater such that ferric sulfate (Fe₂(SO₄)₃) can be produced in large quantities in the wastewater by the oxidation in those instances. Additionally, it is theorized that the ferric cations will bond with hydroxyl groups in the wastewater to form ferric hydroxide (Fe(OH)₃). Other example scenarios can create other ferric compounds, and any ferric compound created is contemplated within the scope of this disclosure.

Since an additional ferrous salt, such as ferrous sulfate, was not blended with the ferric nitrate in this example, consumption of the hydrogen sulfide due to the ferric cation of the ferric nitrate may occur in parallel with and/or subsequent to the oxidation of organic material, such as bacteria, due to the nitrate anion of the ferric nitrate. Without the addition of a ferrous salt, such as ferrous sulfate in the preceding example, the ferric cation is used as the iron source for consuming hydrogen sulfide with ferrous sulfide as a product. The hydrogen sulfide may be present in the wastewater when the ferric nitrate is dispensed in the wastewater and may be subsequently generated, such as when bacteria in the wastewater resumes oxidization using sulfate after the nitrate is spent due to the reactions in Equations (2) and (3).

A multi-step reaction may occur such that a ferric compound, such as ferric sulfate as will be used in this example, may be used to consume hydrogen sulfide and form ferrous sulfide as a product as shown in and described above with respect to Equations (4) and (5). As with above, the reaction of Equation (4) precedes the reaction of Equation (5). Additionally, ferric hydroxide formed from the ferric cation of the ferric nitrate can react with hydrogen sulfide to form ferrous sulfide as shown in Equation (6) above.

In this example, it is also theorized that bacteria in the wastewater may be able to oxidize the ferrous sulfide generated in Equations (5) and (6) to regenerate ferrous sulfate. Energy produced by reactions in Equations (2) and (3) may be able to overcome an activation energy to oxidize the ferrous sulfate. In such a scenario, the reaction of Equation (1) may occur using ferrous sulfate that was regenerated in the wastewater, to form ferrous sulfide, which may precipitate out of the wastewater. In some examples, the ferrous sulfide is not oxidized.

In another example, separate solutions (e.g., aqueous solutions) comprising one or more sources of ferric, nitrate, and/or ferrous may be dispensed in wastewater. For example, a first solution in which a compound including nitrate is mixed is dispensed by a first feeding station at a first location; a second solution in which a compound including ferric is mixed is dispensed by a second feeding station at a second location; and a third solution in which a compound including ferrous is mixed is dispensed by a third feeding station at a third location. The first, second, and third solutions may be a same solution, separate solutions, or any permutation thereof. The first, second, and third feeding stations may be a same feeding station, separate feeding stations, or any permutation thereof. For example, the first, second, and third feeding stations may be within 100 yards of each other, and more particularly, within 50 yards of each other. The first, second, and third locations may be a same location, separate locations, or any permutation thereof. The dispensing of the first, second, and third solutions may be simultaneously, sequentially, or any permutation thereof. For example, the dispensing of various ones of the solutions may occur at any time such that once the solutions have been dispensed in the wastewater, unreacted ferric, unreacted nitrate, and unreacted ferrous are mixed together in the wastewater.

Some examples described herein may allow for a reduced amount of iron being dispensed in a collection system. For example, an increased alkalinity in the wastewater can allow for greater efficiency of reactions with hydrogen sulfide to decompose hydrogen sulfide. Additionally, nitrate can react with hydrogen sulfide, which may reduce an amount of hydrogen sulfide with which iron would otherwise react. Hence, with a reduced amount of iron in the collection system, an amount of sludge at a treatment plant may be reduced.

In view of the entirety of the present disclosure, including the claims and the figures, a person having ordinary skill in the art should readily recognize that the present disclosure introduces a method comprising: dispensing a solution in wastewater, wherein the solution comprises an iron-nitrate compound mixed in water.

The iron-nitrate compound can be ferric nitrate. The iron-nitrate compound can be ferrous nitrate.

The solution may further comprise an iron ion source mixed in the water, where the iron ion source is different from the iron-nitrate compound. The iron ion source can be an iron salt. The iron ion source may be selected from the group consisting of ferrous sulfate, ferrous chloride, and a combination thereof.

The dispensing the solution may comprise operating a discharge control device to control the dispensing of the solution. The solution can be provided in a tank of a feeding station of a wastewater collection system. The discharge control device can be fluidly coupled to the tank. The solution may be dispensed from the tank through the discharge control device to the wastewater.

The present disclosure also introduces a method comprising reacting one or more component of wastewater with one or more component of an aqueous solution, wherein the aqueous solution comprises an iron-nitrate compound mixed therein.

The iron-nitrate compound can be ferric nitrate. The iron-nitrate compound can be ferrous nitrate.

The aqueous solution may further comprise an iron ion source mixed therein, where the iron ion source is different from the iron-nitrate compound. The iron ion source can be an iron salt.

The one or more component of the wastewater can include hydrogen sulfide, and the one or more component of the aqueous solution can include an iron ion of the iron-nitrate compound and a nitrate ion of the iron-nitrate compound. A first molecule of the hydrogen sulfide may react with the iron ion of the iron-nitrate compound, and a second molecule of the hydrogen sulfide may react with the nitrate ion of the iron-nitrate compound.

The method may further comprise dispensing the aqueous solution in the wastewater. Dispensing the aqueous solution can comprise operating a discharge control device to control the dispensing of the aqueous solution. The aqueous solution can be provided in a tank of a feeding station of a wastewater collection system, and the discharge control device can be fluidly coupled to the tank. The aqueous solution can be dispensed from the tank through the discharge control device to the wastewater.

The present disclosure further introduces a method comprising providing a treatment chemical in a tank of a feeding station in a wastewater collection system, and controlling dispensing of the treatment chemical into wastewater in the wastewater collection system. The treatment chemical comprises an aqueous solution with an iron-nitrate compound mixed therein. Controlling the dispensing includes controlling operation of a discharge control device fluidly coupled to the tank of the feeding station using a controller.

The iron-nitrate compound can be ferric nitrate. The iron-nitrate compound can be ferrous nitrate.

The aqueous solution can further comprise an iron ion source mixed therein, where the iron ion source is different from the iron-nitrate compound. The iron ion source can be an iron salt. The iron ion source can be selected from the group consisting of ferrous sulfate, ferrous chloride, and a combination thereof.

The present disclosure also introduces a method comprising dispensing a first solution in wastewater, dispensing a second solution in wastewater, and dispensing a third solution in wastewater. The first solution has a ferric source mixed therein. The second solution has a nitrate source mixed therein. The third solution has a ferrous source mixed therein. After dispensing the first solution, the second solution, and the third solution, the wastewater includes unreacted ferric, unreacted nitrate, and unreacted ferrous simultaneously.

The first solution, the second solution, and the third solution can be the same solution. The first solution, the second solution, and the third solution can be each a different solution.

The first solution can be dispensed at a first location. The second solution can be dispensed at a second location. The third solution can be dispensed at a third location. The second location can be different from the first location, and the third location ca be different from the first location and the second location. The first solution, the second solution, and the third solution can be dispensed simultaneously. The first solution, the second solution, and the third solution can be dispensed at different times.

The first solution, the second solution, and the third solution can be dispensed at a same location. The first solution, the second solution, and the third solution can be dispensed simultaneously. The first solution, the second solution, and the third solution can be dispensed at different times.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. § 1.72(b) to permit the reader to quickly ascertain the nature of the technical disclosure. It is submitted with the understanding that it will not be used to interpret or limit the scope or meaning of the claims.

### ADDITIONAL DESCRIPTION

The following clauses are offered as further description of the disclosed invention.
1. A method comprising:

dispensing a solution in wastewater, wherein the solution comprises an iron-nitrate compound mixed in water.
2. The method of any proceeding or preceding clause, wherein the iron-nitrate compound is ferric nitrate.
3. The method of any proceeding or preceding clause, wherein the solution further comprises an iron ion source mixed in the water, the iron ion source being different from the iron-nitrate compound.
4. The method of any proceeding or preceding clause, wherein the iron ion source is an iron salt.
5. The method of any proceeding or preceding clause, wherein the iron ion source is selected from the group consisting of ferrous sulfate, ferrous chloride, and a combination thereof.
6. The method of any proceeding or preceding clause, wherein dispensing the solution comprises operating a discharge control device to control the dispensing of the solution, wherein the solution is provided in a tank of a feeding station of a wastewater collection system, wherein the discharge control device is fluidly coupled to the tank, and wherein the solution is dispensed from the tank through the discharge control device to the wastewater.
7. A method comprising:

reacting one or more component of wastewater with one or more component of an aqueous solution, wherein the aqueous solution comprises an iron-nitrate compound mixed therein.
8. The method of any proceeding or preceding clause, wherein the iron-nitrate compound is ferric nitrate.
9. The method of any proceeding or preceding clause, wherein the aqueous solution further comprises an iron ion source mixed therein, the iron ion source being different from the iron-nitrate compound.
10. The method of any proceeding or preceding clause, wherein the iron ion source is an iron salt.
11. The method of any proceeding or preceding clause, wherein the one or more component of the wastewater includes hydrogen sulfide, and the one or more component of the aqueous solution includes an iron ion of the iron-nitrate compound and a nitrate ion of the iron-nitrate compound, wherein a first molecule of the hydrogen sulfide is reacted with the iron ion of the iron-nitrate compound, and a second molecule of the hydrogen sulfide is reacted with the nitrate ion of the iron-nitrate compound.
12. The method of any proceeding or preceding clause further comprising dispensing the aqueous solution in the wastewater, wherein dispensing the aqueous solution comprises operating a discharge control device to control the dispensing of the aqueous solution, wherein the aqueous solution is provided in a tank of a feeding station of a wastewater collection system, wherein the discharge control device is fluidly coupled to the tank, and wherein the aqueous solution is dispensed from the tank through the discharge control device to the wastewater.
13. A method comprising:

providing a treatment chemical in a tank of a feeding station in a wastewater collection system, wherein the treatment chemical comprises an aqueous solution with an iron-nitrate compound mixed therein; and

controlling dispensing of the treatment chemical into wastewater in the wastewater collection system, wherein controlling dispensing includes controlling operation of a discharge control device fluidly coupled to the tank of the feeding station using a controller.
14. The method of any proceeding or preceding clause, wherein the iron-nitrate compound is ferric nitrate.
15. The method of any proceeding or preceding clause, wherein the aqueous solution further comprises an iron ion source mixed therein, the iron ion source being different from the iron-nitrate compound.
16. The method of any proceeding or preceding clause, wherein the iron ion source is an iron salt.
17. The method of any proceeding or preceding clause, wherein the iron ion source is selected from the group consisting of ferrous sulfate, ferrous chloride, and a combination thereof.
18. A method comprising:

dispensing a first solution in wastewater, the first solution having a ferric source mixed therein;

dispensing a second solution in wastewater, the second solution having a nitrate source mixed therein; and

dispensing a third solution in wastewater, the third solution having a ferrous source mixed therein, wherein after dispensing the first solution, the second solution, and the third solution, the wastewater includes unreacted ferric, unreacted nitrate, and unreacted ferrous simultaneously.
19. The method of any proceeding or preceding clause, wherein the first solution, the second solution, and the third solution are the same solution.
20. The method of any proceeding or preceding clause, wherein the first solution, the second solution, and the third solution are each a different solution.
21. The method of any proceeding or preceding clause, wherein:

the first solution is dispensed at a first location;

the second solution is dispensed at a second location different from the first location; and

the third solution is dispensed at a third location different from the first location and the second location.
22. The method of any proceeding or preceding clause, wherein the first solution, the second solution, and the third solution are dispensed simultaneously.
23. The method of any proceeding or preceding clause, wherein the first solution, the second solution, and the third solution are dispensed at different times.
24. The method of any proceeding or preceding clause, where the first solution, the second solution, and the third solution are dispensed at a same location.
25. The method of any proceeding or preceding clause, wherein the first solution, the second solution, and the third solution are dispensed simultaneously.
26. The method of any proceeding or preceding clause, wherein the first solution, the second solution, and the third solution are dispensed at different times.

What is claimed is:

1. A method comprising:
dispensing a solution in wastewater, wherein the solution comprises an iron-nitrate compound mixed in water.

2. The method of claim 1, wherein the iron-nitrate compound is ferric nitrate.

3. The method of claim 1, wherein the solution further comprises an iron ion source mixed in the water, the iron ion source being different from the iron-nitrate compound.

4. The method of claim 3, wherein the iron ion source is an iron salt.

5. The method of claim 3, wherein the iron ion source is selected from the group consisting of ferrous sulfate, ferrous chloride, and a combination thereof.

6. The method of claim 1, wherein dispensing the solution comprises operating a discharge control device to control the dispensing of the solution, wherein the solution is provided in a tank of a feeding station of a wastewater collection system, wherein the discharge control device is fluidly coupled to the tank, and wherein the solution is dispensed from the tank through the discharge control device to the wastewater.

7. A method comprising:
reacting one or more component of wastewater with one or more component of an aqueous solution, wherein the aqueous solution comprises an iron-nitrate compound mixed therein.

8. The method of claim 7, wherein the iron-nitrate compound is ferric nitrate.

9. The method of claim 7, wherein the aqueous solution further comprises an iron ion source mixed therein, the iron ion source being different from the iron-nitrate compound.

10. The method of claim 9, wherein the iron ion source is an iron salt.

11. The method of claim 7, wherein the one or more component of the wastewater includes hydrogen sulfide, and the one or more component of the aqueous solution includes an iron ion of the iron-nitrate compound and a nitrate ion of the iron-nitrate compound, wherein a first molecule of the hydrogen sulfide is reacted with the iron ion of the iron-nitrate compound, and a second molecule of the hydrogen sulfide is reacted with the nitrate ion of the iron-nitrate compound.

12. The method of claim 7 further comprising dispensing the aqueous solution in the wastewater, wherein dispensing the aqueous solution comprises operating a discharge control device to control the dispensing of the aqueous solution, wherein the aqueous solution is provided in a tank of a feeding station of a wastewater collection system, wherein the discharge control device is fluidly coupled to the tank, and wherein the aqueous solution is dispensed from the tank through the discharge control device to the wastewater.

13. A method comprising:
providing a treatment chemical in a tank of a feeding station in a wastewater collection system, wherein the treatment chemical comprises an aqueous solution with an iron-nitrate compound mixed therein; and
controlling dispensing of the treatment chemical into wastewater in the wastewater collection system, wherein controlling dispensing includes controlling operation of a discharge control device fluidly coupled to the tank of the feeding station using a controller.

14. The method of claim 13, wherein the iron-nitrate compound is ferric nitrate.

15. The method of claim 13, wherein the aqueous solution further comprises an iron ion source mixed therein, the iron ion source being different from the iron-nitrate compound.

16. The method of claim 15, wherein the iron ion source is an iron salt.

17. The method of claim 15, wherein the iron ion source is selected from the group consisting of ferrous sulfate, ferrous chloride, and a combination thereof.
